(19) United States
(12) Patent Application Publication
(10) Pub. No.: US 2026/0145574 A1
(43) Pub. Date: May 28, 2026

(54) METHOD OF CONTROLLING ELECTRIC POWER USAGE OF VEHICLE HAVING STAY MODE

(71) Applicants: HYUNDAI MOTOR COMPANY, Seoul (KR); KIA CORPORATION, Seoul (KR)

(72) Inventors: Yong Joo Lee, Hwaseong-si (KR); Ji Hoon Kang, Hwaseong-si (KR); Ha Kyung Lee, Hwaseong-si (KR); Byung Cheon Son, Hwaseong-si (KR); Dong Su Ha, Hwaseong-si (KR)

(73) Assignees: HYUNDAI MOTOR COMPANY, Seoul (KR); KIA CORPORATION, Seoul (KR)

(21) Appl. No.: 19/263,481

(22) Filed: Jul. 8, 2025

(30) Foreign Application Priority Data
Nov. 28, 2024 (KR) 10-2024-0173313

(51) Int. Cl. B60L 58/12

(52) U.S. Cl. CPC B60L 58/12; B60L 2250/16; B60L 2260/40

(57) ABSTRACT

The present disclosure provides a method of controlling electric power usage of a vehicle having a stay mode including displaying information on usage modes of the stay mode in an activated state of stay mode. When one of the usage modes is selected by a user, the method determines total operating power of all electric devices in the selected usage mode based on setting information on an operating status of each electric device set for the corresponding usage mode and determining an integrated power limit from the determined total operating power. The method also includes determining a power limit of each electric device distributed from the determined integrated power limit based on the setting information, and operating each electric device using battery power depending on the setting information and limiting power usage of each electric device depending on the determined power limit of each electric device.

### CROSS-REFERENCE TO RELATED APPLICATION(S)

This application claims under 35 U.S.C. § 119(a) the benefit of priority from Korean Patent Application No. 10-2024-0173313 filed on Nov. 28, 2024, the entire contents of which are incorporated herein by reference.

### TECHNICAL FIELD

The present disclosure relates to a method of controlling electric power usage when an electrified vehicle uses a stay mode.

### BACKGROUND

Recently, as the era of high oil prices continues, the demand for electrified vehicles is increasing, and the proportion of electrified vehicles among all vehicles is expected to gradually increase in the future.

Electrified vehicles may be vehicles that use an electric motor as a driving device to drive the vehicle, and among electrified vehicles, a hybrid electric vehicle is a vehicle that uses both an engine and a motor as driving devices to drive the vehicle.

In the hybrid electric vehicle, an electric vehicle (EV) mode in which the vehicle is driven only using the power of the motor, and a hybrid electric vehicle (HEV) mode in which the vehicle is driven using the combined power of the engine and the motor are provided.

For this purpose, the hybrid electric vehicle is equipped with an engine clutch that connects or disconnect the engine and the motor to enable power transmission, and in the EV mode, only the power of the motor is transmitted to driving wheels through a transmission in the disengaged state of the engine clutch.

On the other hand, in the HEV mode, the engine and the motor, which are the driving devices, are connected to enable power transmission by engaging the engine clutch, and accordingly the combined power of the engine and the motor is transmitted to the driving wheels through the transmission.

In addition, the hybrid electric vehicle is equipped with a battery as a power source, and the motor is connected to the battery through an inverter to enable charging and discharging of the battery. In the hybrid electric vehicle, the engine and the motor may be used as generators to charge the battery, and when the rotational power of the engine or the rotational power of the driving wheels is transmitted to the motor, the motor is operated as the generator to charge the battery.

In this case, the motor operated as the generator may be a motor (e.g., drive motor) that drives the vehicle, or a separate motor directly connected to the engine, such as a hybrid starter generator (HSG) or a motor interposed between the engine and the engine clutch to enable power transmission.

Meanwhile, the lifestyle patterns of vehicle users have recently changed significantly, and there are more cases in which a vehicle user waits or rests for a long period of time while staying in a parked vehicle, or a vehicle user performs personal tasks, such as applying makeup or work while staying in a parked vehicle.

In addition, the frequency of charging electronic devices with vehicle electricity, using multimedia devices (e.g., audio and video devices) or air conditioners, or using electronic devices, such as a hair dryer, a humidifier, a laptop, a game console, and a smartphone, with vehicle electricity is also increasing, and accordingly, development to further improve the interior livability of electrified vehicles may be useful.

For example, a mode in which a vehicle is electrically connected to an external power supply and uses power supplied from the external power supply for various purposes may be known.

Separately from this, idle charging in which the motor or the generator is operated with engine power to generate power while idling the engine, which is a self-generation device, in order to use electric devices, such as an air conditioner, in a hybrid electric vehicle equipped with a high-voltage battery may be known.

In the case of a hybrid electric vehicle (e.g., a general hybrid electric vehicle, not a plug-in hybrid electric vehicle) that is in a place where the vehicle cannot be connected to an external power supply device, or cannot be connected to an external power supply device, idle charging in which the engine is driven to charge a battery with a motor (e.g., a HSG or the like) may be used to continuously use vehicle power for a long period of time, and such idle charging may cause problems, such as engine noise, vibration, and exhaust fumes. In addition, when idling for a long time, problems, such as violation of regulations and decreased engine durability, may occur.

Accordingly, it may be useful to manage vehicle power (e.g., battery power) so that electric devices may be used for a long time in a parked vehicle without performing idle charging using engine idling in the parked vehicle.

In this regard, research and development on a stay mode that allows a user to perform various indoor and outdoor activities while using vehicle power in a parked vehicle in a stopped state in the park (P) gear position may be useful.

In general, in the stay mode, the maximum available time when vehicle power is usable is displayed through a display considering a real-time battery status and a power usage status, thereby informing a stay mode user, such as a driver.

However, conventionally, if a time when vehicle power is usable was displayed in a parked vehicle, a user had to adjust the vehicle power considering the displayed time, and excessive power was wasted unnecessarily due to operation of functions which were not used during execution of the stay mode and made it difficult to secure a sufficient usage time.

The above information disclosed in this Background section is for enhancement of understanding of the background of the disclosure and therefore it may contain information that does not form the prior art that is already known to a person of ordinary skill in the art.

### SUMMARY

The present disclosure has been made in an effort to solve the above-described problems associated with prior art, and the present disclosure provides a method of controlling electric power usage of a vehicle having a stay mode that may secure a longer power usage time through efficient power usage control while the stay mode is being performed at a user's request.

The present disclosure also provides a method of controlling electric power usage of a vehicle having a stay mode that provides a user (e.g., driver) with various information related to power usage when using the stay mode, allows stay mode settings to be customized for the user so that the stay mode may be used in a personalized manner, and enables the stay mode to be more efficiently used based on information learned depending on the user or usage position of the stay mode.

In one aspect, the present disclosure provides a method of controlling electric power usage of a vehicle having a stay mode including displaying, by a control unit, information on available detailed usage modes of the stay mode through a display in an activated state of stay mode. When one of the detailed usage modes is selected through an input device, the method includes determining, by the control unit, total operating power of (e.g., all) electric devices set to be operated in the selected detailed usage mode based on setting information on an operating status of each electric device set for the corresponding detailed usage mode. The method also includes determining an integrated power limit, which is maximum available power in the selected detailed usage mode, from the determined total operating power of (e.g., all) the electric devices, and determining, by the control unit, a power limit of each electric device distributed from the determined integrated power limit based on the setting information on the operating status of each electric device. The method further includes operating, by the control unit, each electric device using battery power depending on the setting information on the operating status of each electric device, and limiting power usage of each electric device depending on the determined power limit of each electric device during operation of each electric device.

In an example embodiment, the controller may be configured such that a plurality of detailed usage modes is set therein, and a user may select one of the plurality of set detailed usage modes.

In another example embodiment, the detailed usage modes may include a custom mode created by a user, and the custom mode may be a detailed usage mode created by selecting, by the user, electric devices desired to be operated and setting, by the user, setting information on operating statuses of the selected electric devices and storing the setting information in the controller.

In still another example embodiment, the method may further include determining, by the controller, user profile information input or selected by the user, and the controller may determine the user from the input or selected user profile information, and then display information on detailed usage modes configured to be available to the determined user.

In yet another example embodiment, the method may further include displaying, by the control unit, information configured to enable selection or input of activation of the stay mode through the display, if the vehicle is stopped and is in a park (P) gear position input state, and activating, by the control unit, the stay mode, if the user selects or inputs the activation of the stay mode through the input device.

In still yet another example embodiment, the electric devices may be devices operated using the battery power, and include at least one of an air conditioner, a seat, an audio device, a video device, a lighting device, or a heating device.

In a further example embodiment, the power limit of each electric device may include at least one of an air conditioner power limit configured to limit operating power of an air conditioner, a converter power limit configured to limit operating power of electric devices configured to receive the battery power through a converter, or a heating device power limit configured to limit operating power of a heating device. In addition, in determining the integrated power limit, the controller may determine the integrated power limit as a value obtained by subtracting a predetermined margin from the total operating power of (e.g., all) the electric devices.

In another further example embodiment, in determining the power limit of each electric device, the controller may determine operating power of each electric device set to be operated in the selected detailed usage mode based on the setting information on the operating status of each electric device, and determine the power limit of each electric device, which is the maximum available power of each electric device, by distributing the integrated power usage limit based on the determined operating power of each electric device.

In still another further example embodiment, if the setting information on the operating status of each electric device is changed by additional user manipulation during execution of the selected detailed usage mode, and the operating power of each electric device exceeds the power limit of each electric device while each electric device is operated depending on the change setting information, the controller may terminate and release the stay mode.

In yet another further example embodiment, the controller may determine an expected available time, which is a maximum time for which the selected detailed usage mode is available, based on a power usage status of each electric device and battery status information, and display the determined expected available time through the display.

Other aspects and example embodiments of the disclosure are discussed herein. The above and other features of the disclosure are discussed herein.

### BRIEF DESCRIPTION OF THE DRAWINGS

The above and other features of the present disclosure will now be described in detail with reference to certain exemplary embodiments thereof illustrated in the accompanying drawings, and thus are not limitative of the present disclosure.

FIG. 1 is a diagram for power usage control in a stay mode according to the present disclosure;

FIG. 2 is a block diagram of the configuration of a power usage control system of an electrified vehicle to which the present disclosure is applied;

FIG. 3 is a diagram for a method of setting a custom mode in the present disclosure;

FIG. 4 is a block diagram of detailed components and functions, input variables, and output variables of a control unit that performs power usage control according to the present disclosure; and

FIG. 5 is a flowchart of a power usage control process according to the present disclosure.

It should be understood that the appended drawings may not be necessarily to scale, presenting a somewhat simplified representation of various example features illustrative of the basic principles of the disclosure. The specific design features of the present disclosure as disclosed herein, including, for example, specific dimensions, orientations, positions, and shapes may be determined in part by the particular intended application and use environment.

In the figures, reference numbers may refer to the same or equivalent parts of the present disclosure throughout the several figures.

### DETAILED DESCRIPTION

Hereinafter, embodiments of the present disclosure will be described in detail with reference to the accompanying drawings. Specific structural or functional descriptions set forth in the embodiments of the present disclosure may be exemplarily and given to describe the embodiments depending on the concept of the present disclosure, and the embodiments depending on the concept of the present disclosure may be embodied in different forms. Further, the present disclosure should not be construed as being limited to the embodiments set forth herein, and it may be understood that the present disclosure includes modifications, equivalents, or substitutes included in the spirit and technical scope of the disclosure.

In the following description of the embodiments, terms, such as “first” and “second,” and the like, are used to describe various elements, and these elements should not be construed as being limited by these terms. These terms are used to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” and the like

Wherever possible, the same reference numbers will be used throughout the following description to refer to the same or like parts. The terminology used herein is for the purpose of describing particular embodiments and is not intended to be limiting. As used herein, singular forms may be intended to include plural forms as well, unless the context indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

The present disclosure may be applied to a vehicle having a stay mode, and the vehicle to which the present disclosure is applied may be an electrified vehicle, and specifically, may be a hybrid electric vehicle equipped with an engine and a motor that drive the vehicle, a rechargeable battery, and a power conversion device, such as a converter that may convert battery power and supply and distribute the converted power to electric devices.

In the present disclosure, the stay mode may be a mode in which battery power is used while using electric devices installed in or connected to a vehicle inside/outside of the parked vehicle in the park (P) gear position.

In addition, in the present disclosure, the stay mode may be a mode in which, when it is activated through user selection in the stopped state of a vehicle in the P gear position, the usage status of battery power may be maintained without performing idle charging using an engine and a motor (e.g., an HSG or the like).

In a general hybrid electric vehicle, idle charging is performed when the SoC (state of charge) of a battery falls below a predetermined SoC threshold, and an SoC threshold in the stay mode may be set to be lower than an SoC threshold in the normal mode.

The reason for this is that it is considered that the stay mode is a mode to secure as long as a power usage time as possible while preventing idle charging in a situation in which the idle charging time is limited by regulations.

In addition, the SoC threshold in the stay mode is not a threshold for idle charging, and when the user selects activation of the stay mode and the vehicle enters the stay mode, if the SoC of the battery becomes lower than the SoC threshold, idle charging is not performed and the engine of the vehicle is turned off.

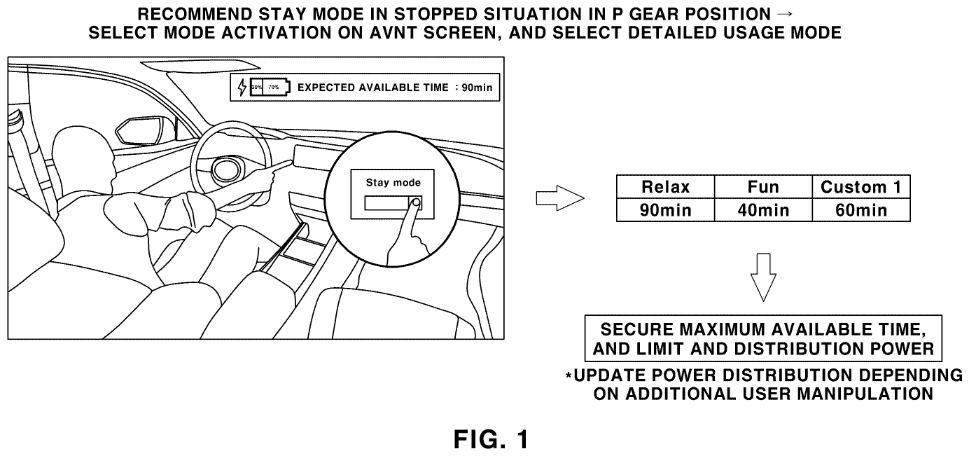

FIG. 1 is a diagram for explaining power usage control in a stay mode according to the present disclosure, and shows an example in which a driver activates the stay mode by operating a touchscreen, which is an input device, inside a vehicle.

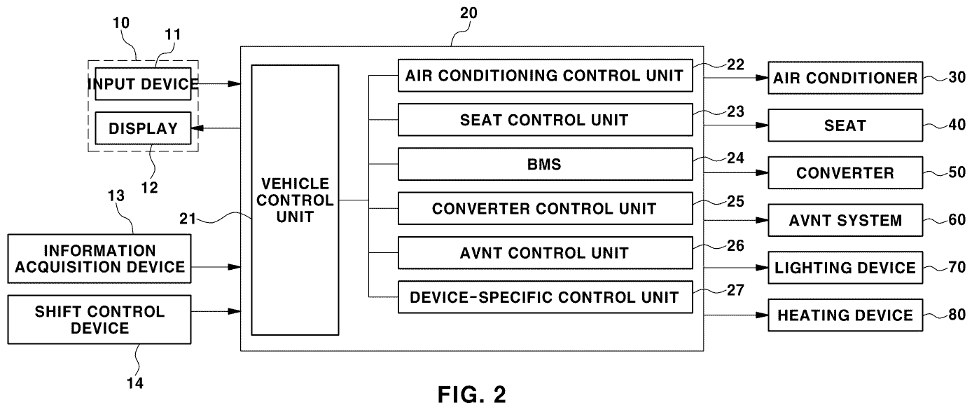

FIG. 2 is a block diagram showing the configuration of a power usage control system of an electrified vehicle to which the present disclosure is applied, and shows examples of input elements, output elements, control units, and operating elements that are provided to perform a power usage control process according to the present disclosure.

In the present disclosure, an interface unit 10 includes an input device 11 and a display 12, and although FIG. 2 shows the interface unit 10 separately from an audio, video, navigation and telematics (AVNT) device 60, the input device 11 and the display 12 of the interface unit 10 may be the input device and the display of the AVNT system 60, and more specifically, may be the touchscreen of the AVNT system 60 that performs the integrated functions of the input device and the display.

In the present disclosure, when the driver inputs the park (P) gear position through a shift control device 14 after the vehicle stops, a control unit 20 of the vehicle controls operation of the display 12 (e.g., the touchscreen) to recommend entry to the stay mode.

In the present disclosure, if the vehicle is stopped in the P gear position input state for a set time, the control unit 20 may determine that the vehicle is in the parked state and recommend entry into the stay mode, and at this time, may allow a user, such as the driver, to select activation of the stay mode.

Specifically, the control unit 20 may control operation of the display 12 to display information that allows the user to select or input activation of the stay mode in the form of a pop-up message, or the like.

Thereafter, if the user, such as the driver, selects or inputs activation of the stay mode through the input device 11, the control unit 20 may recognize that the user has selected activation of the stay mode and enter the stay mode.

In the present disclosure, the user selecting activation of the stay mode may be referred to as the user turning on the stay mode. In the example of FIG. 1, when the user touches “Stay mode” displayed on the touchscreen and slides the same sideways, activation of the stay mode is selected.

In addition, the control unit 20 may control operation of the display 12 to display an expected available time of the stay mode. Here, the expected available time of the stay mode is an expected time during which the stay mode may be used (e.g., to the maximum) without performing idle charging by the engine and the motor (e.g., the HSG, or the like), and may be calculated in real time by the control unit 20 during the stay mode and displayed on the display 12.

After the user activates the stay mode, the control unit 20 controls the display 12 (e.g., touchscreen) of the interface unit 10 to display information on a plurality of detailed usage modes set as sub-modes in the stay mode and at the same time display information that allows the user to select a desired usage mode.

At this time, the control unit 20 may display selectable detailed usage modes through the display 12 based on information indicating the usage pattern of the stay mode, such as information on the user, previous usage position and usage time, and setting information on the operating status of each electric device used, among the plurality of detailed usage modes, and recommend selection and use of one of the detailed usage modes through this process.

Accordingly, the control unit 20 may perform predetermined control depending on the setting information of the detailed usage mode selected by the user to execute the selected detailed usage mode during the stay mode in the state of entering the stay mode.

Here, the setting information may include setting values required to operate electric devices in the vehicle, which are operated or controlled in the detailed usage mode, and the setting values may be setting values learned through repeated use of the detailed usage mode by the corresponding user. The setting values may include setting values that the user has changed through (e.g., additional) manipulation when using the detailed usage mode.

Even if the information to select activation of the stay mode is displayed through the display 12, such as the touchscreen, as described above, the user may not select activation of the stay mode.

In the present disclosure, the control unit 20 may learn the usage pattern of the stay mode by analyzing the setting information on the user, the usage position, and the usage time of the stay mode, and the operating status of each electric device used, classify the stay mode usage case of the corresponding user based on the learned usage pattern information, and when the same usage case is repeatedly learned by the same user at the same usage position and usage time, define the learned usage case and the operating status and setting information of each electric device in this case as a new detailed usage mode (e.g., a relax mode, or a custom mode 1 or 2), and add the new detailed usage mode to the existing detailed usage modes.

Here, if there is a newly added detailed usage mode, the name of the added detailed usage mode may be set and stored by the user through the input device 11, and the setting information on the operating status of each electric device used at this time may be stored as setting information of the corresponding detailed usage mode.

In addition to the detailed usage mode created and added based on the user's learned usage pattern information, the plurality of detailed usage modes set and stored as sub-modes of the stay mode in the control unit 20 from the time when the vehicle is released may be provided, and these detailed usage modes may be executed by driver selection in the activated state of the stay mode.

The setting values of the detailed usage modes stored at the time of releasing the vehicle may be changed by driver manipulation and then stored, and in the case of the detailed usage mode having the changed setting values, the changed setting values may be stored and maintained in the control unit 20 until manipulation for initialization.

In this way, after entering the stay mode, the usage case of the stay mode may be classified and then created and provided as a new detailed usage mode, and a selected detailed usage mode may be executed (e.g., only) by selecting one of the detailed usage modes by the user, thereby being capable of minimizing unnecessary user manipulation when using the stay mode. Here, the detailed usage modes of the stay mode may be sub-modes in the stay mode which are selectable when the stay mode is activated.

In more detail, in the present disclosure, the operating statuses of the electric devices in the vehicle that are predetermined for each detailed usage mode may be controlled depending on the setting values of the corresponding mode, and, for example, the on/off of an air conditioner 30, the operating status (e.g., air volume) and operation mode (e.g., internal/external air mode) of the air conditioner 30, the on/off of an Ergo motion seat 40, the on/off of the AVNT system 60, such as an audio device, the brightness of the display 12, the on/off of a lighting device 70, such as a vehicle interior light, the on/off of a heating device 80, such as a seat heating wire, the operating statuses and operation modes of the lighting device 70 and the heating device 80, and the like may be controlled.

In the present disclosure, the Ergo motion seat is a seat configured to adjust the air pressure of the seat to provide the optimal seating comfort that suits the body type and posture of the driver and/or a passenger.

The Ergo motion seat includes a plurality air pockets disposed in a seat cushion, a seat back, and both side bolsters, and controls the amount of air in the air pockets as needed to adjust the passenger's posture, seat cushion feel, and the like to a passenger's desired level.

The Ergo motion seat is a seat convenience device widely applied to vehicles.

In the present disclosure, the detailed usage modes of the stay mode may include a silent mode, a relax mode, a fun mode, and a cafe mode, and these modes may be modes set when the vehicle is released (e.g., factory setting modes). In addition, the detailed usage modes of the stay mode may further include a custom mode set by the user.

Referring to FIG. 1, several examples of the detailed usage modes are shown, and as the detailed usage modes of the stay mode, the relax mode (“Relax”), the fun mode (“Fun”), and the custom mode 1 (“Custom 1”) are illustrated.

Here, the custom mode is a mode that the user creates (e.g., directly) by setting detailed functions in advance, and one custom mode or a plurality of custom modes may be set in the control unit 20.

When creating a custom mode, the user selects electric devices desired to be operated and then (e.g., directly) sets setting values regarding the operating statuses of the selected electric devices, and the setting values are stored and used as setting information of the corresponding custom mode in the control unit 20.

As shown in FIG. 1, information to select one of the relax mode (“Relax”), the fun mode (“Fun”), and the custom mode 1 (“Custom 1”) is displayed on the display 12, and the user may select one of the three displayed detailed usage modes through the input device 11. Referring to FIG. 1, an expected available time of each detailed usage mode is displayed, and the expected available time indicates the maximum time for which power can be used.

When one of the three detailed usage modes is selected by the user in the vehicle in which the stay mode is activated, the selected detailed usage mode may be executed under the control of the control unit 20.

The electric devices in the vehicle (e.g., at this time) are controlled depending on the setting information set in the selected detailed usage mode, and the operating statuses of the electric devices in the vehicle may be adjusted or the electric devices are turned on or off depending on the setting information.

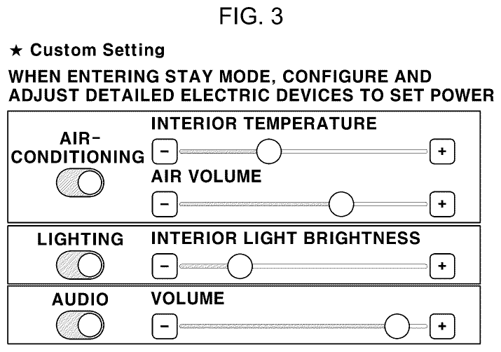

FIG. 3 is a diagram for a method of setting a custom mode in the present disclosure, and shows examples of setting the air conditioner, the lighting device, and the audio device. After activating and entering the stay mode, the user may set the operating status of each electric device to a desired level as shown in the set mode, and the setting value at this time may be stored as a setting value in the newly created custom mode. The setting value in the custom mode may be changed and adjusted to a desired value by the user.

In addition, it is possible to additionally adjust the settings regarding the operating status of each electric device, such as an intensity, in addition to turning-on/off. For example, in the case of the Ergo motion seat, the intensity of the massage function of the Ergo motion seat or an area where the massage function is executed may be set, and in the case of the air conditioner, an area where the air-conditioning function is executed, such as a first row, a second row, or a third row, may be selected in addition to setting of the temperature.

In addition, in the present disclosure, the control unit 20 may calculate the expected available time (e.g., expected available time of each detailed usage mode) based on the power usage status and battery status (e.g., battery SoC and the like) information depending on the setting information of each detailed usage mode of the stay mode, in addition to the expected available time of the entirety of the stay mode (e.g., expected available time of the stay mode), and then control operation of the display 12 to display the calculated expected available time of each detailed usage mode.

In the example of FIG. 1, the expected power available time (e.g., the expected available time) of the relax mode is 90 minutes, the expected power available time of the fun mode is 40 minutes, and the expected power available time of the custom mode 1 is 60 minutes.

Subsequently, when the user checks the displayed information and selects or inputs a desired usage mode through the input device 11, control to limit and distribute an power usage amount for the electric devices (electric and electronic devices) in the vehicle is performed as control to secure the maximum power usage time of the stay mode.

Here, the electric devices in the vehicle are devices that are operated with battery power, and may include at least one of the air conditioner 30, the Ergo motion seat 40, the audio device and the video device of the AVNT system 60, the lighting device 70, or the heating device 80.

In the present disclosure, a method of controlling the output of a converter 50 that converts battery power and supplies the converted power to each electric device may be used in a control process of limiting and distributing the power usage amount.

In addition, in the present disclosure, as described below, a power limit of each electric device that uses the battery power is determined for each detailed usage mode, and an air conditioner power limit may be determined for each detailed usage mode.

In addition, because the Ergo motion seat 40, the AVNT system 60, and the lighting device 70 receive the power converted from the battery power by the converter 50, a converter power limit may be determined as an integrated power limit. Further, in the case of the heating device 80, such as the seat heating wire or a knee heater in the vehicle, a heating device power limit may be determined separately.

In this way, the power limit of each electric device may include at least one of the air conditioner power limit to limit the operating power of the air conditioner 30, the converter power limit to limit the operating powers of the electric devices supplied with battery power through the converter 50, or the heating device power limit to limit the operating power of the heating device 80 including the seat heating wire.

The converter may be a general low voltage DC-DC converter (LDC), which is mounted in a hybrid electric vehicle, and the LDC is a converter that performs power conversion between a high voltage system and a low voltage system.

In the present disclosure, the power usage of the electric devices may be set to be within the power limit for each detailed usage mode in the stay mode, and if the power usage of the electric devices exceeds the power limit, the stay mode may be released.

If there is an additional operation input by the user for each electric device through the input device 11 after selecting the usage mode, the control unit 20 may perform power usage amount limitation and distribution information update depending on the additional input information.

In the present disclosure, the control unit 20 calculates the power limit of each electric device set to be operated during the stay mode, and then limits the operating power of each electric device to the calculated power limit. That is, after entering the stay mode, the control unit 20 calculates the power limit of each electric device by calculating required energy for each usage mode, and limits the operating power of each electric device to the power limit of each electric device.

For this purpose, the control unit 20 in the present disclosure acquires (e.g., necessary) information, such as an ambient temperature and the interior temperature of the vehicle at a vehicle position (e.g., stay position) where the stay mode is performed in the parked state of the vehicle in the P gear position, determines (e.g., required) power for each usage mode of the stay mode, and performs (e.g., optimal) control depending the power usage limit of each electric device. As an example of the above optimal control, the operating status of the air conditioner 30, the screen brightness of the AVNT system 60, and the audio volume of the AVNT system 60, and the like may be optimally controlled depending on the power usage limit of each electric device.

In the present disclosure, control subjects may be a plurality of control units. For example, an upper-level control unit and lower-level control units that perform mutual cooperative control may be the control subjects of the power usage control process according to the present disclosure.

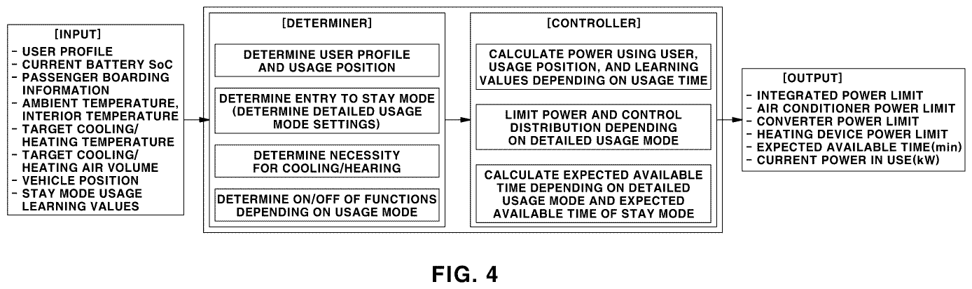

The upper-level control unit may be a vehicle control unit (VCU) 21 that controls the overall operation of a hybrid electric vehicle. A control unit of FIG. 4 described below may be the vehicle control unit 21, which is the upper-level control unit in FIG. 2, and may include a determiner and a controller (see FIG. 4).

The lower-level control units may be control units for the respective electric devices installed in the vehicle. For example, the lower-level control units may include, as shown in FIG. 2, an air conditioning control unit 22, a seat control unit 23, a battery management system (BMS) 24, a control unit 25 for the power conversion device, such as the converter 50 (“converter control unit”), a control unit 26 for the AVNT system 60 (“AVNT control unit”), and a device-specific control unit 27 for the lighting device 70 or the heating device 80.

Alternatively, the power usage control process according to the present disclosure may be performed by a single control element having an integrated function and form, instead of the above-described plurality of control units. In the present disclosure, the plurality of control units and the single integrated control element may (e.g., all) be collectively referred to as a control unit, and the power usage control process according to the present disclosure described below may be performed by the control unit 20.

In the power usage control system according to an example embodiment of the present disclosure, the input device 11 and the display 12 of the interface unit 10 may be the input device and the display of the AVNT system 60, as described above, and more specifically, may be the touchscreen of the AVNT system 60 that performs the integrated functions of the input device and the display.

As described above, in the present disclosure, use and entry of the stay mode is recommended while displaying the information (e.g., message, and the like) to select activation of the stay mode through the display 12, and the user selects or inputs activation of the stay mode through the input device 11.

In addition, the input device 11 and the display 12 may be used to select or input and display information related to execution and control of the stay mode including the power usage control process according to the present disclosure.

Further, in the power usage control system according to the present disclosure, an information acquisition device 13, which is an input element, serves to detect information required in the process of performing the power usage control process, and may include a plurality of sensors electrically connected to the control unit 20. The plurality of sensors may be sensors configured to detect vehicle status information and environmental information.

Specifically, the information acquisition device 13 may include an ambient temperature sensor that detects the ambient temperature, an interior temperature sensor that detects the interior temperature of the vehicle, and a GPS receiver configured to acquire vehicle position information.

Accordingly, the control unit 20 may acquire current ambient temperature information in real time from a signal from the ambient temperature sensor, and may acquire current vehicle interior temperature information in real time from a signal from the interior temperature sensor.

In addition, the control unit 20 may acquire current vehicle position information in real time by receiving a signal from the GPS receiver (i.e., a GPS signal indicating the vehicle position information). The control unit 20 may acquire the vehicle position information by (e.g., directly) receiving the signal from the GPS receiver, or the control unit 20 may receive the current vehicle position information from a navigation system including the GPS receiver among the AVNT system 60.

In addition, the information acquisition device 13 may further include a passenger detection sensor that detects the boarding position of a passenger in the vehicle, and accordingly, the control unit 20 may acquire passenger boarding information in the interior of the vehicle when the stay mode is activated from a signal from the passenger detection sensor.

The passenger detection sensor may be a sensor installed for each seat in the vehicle, and the control unit 20 may be provided to determine the passenger boarding position by distinguishing front and rear seats from the signal from the passenger detection sensor.

Alternatively, in the case of the front seats, the passenger detection sensor may be installed in each of the driver's seat and the front passenger's seat, or in the case of the rear seats, the passenger detection sensor may be installed in each of the left seat and the right seat, and in this case, the control unit 20 may determine whether a passenger is on board at each position of the vehicle interior from a signal from each passenger detection sensor.

In addition, in the power usage control system according to the present disclosure, the operating elements may include, as described above, the air conditioner 30, the seat 40, the power conversion device, such as the converter 50, the AVNT system 60, the lighting device 70, and the heating device 80, and the display 12 of the interface unit 10 may be a component whose operation is controlled by the control unit 20, and may be said to be both an output element and an operating element.

Hereinafter, the power usage control system and method of the vehicle according to the present disclosure will be described in more detail.

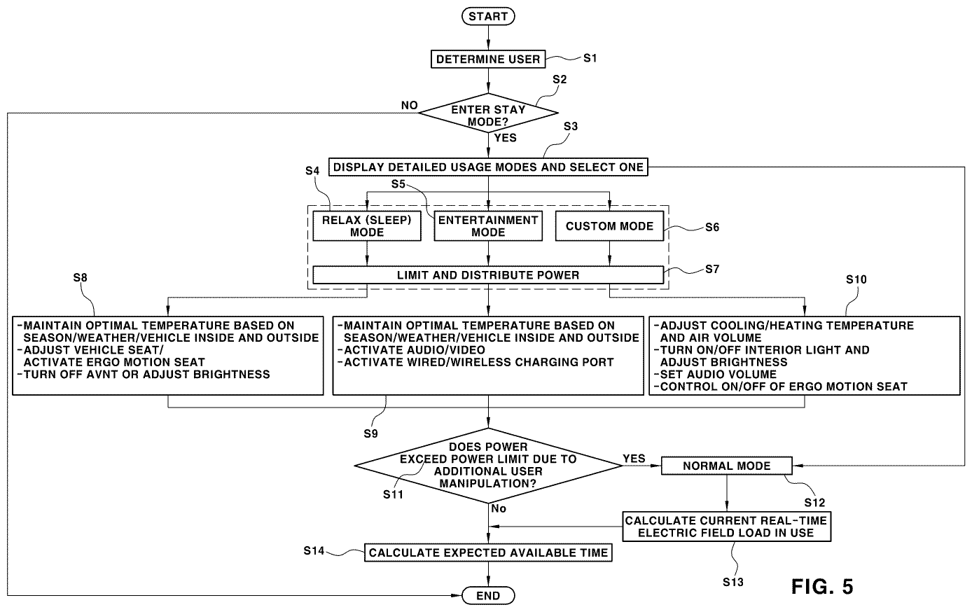

FIG. 4 is a block diagram illustrating detailed components and functions, input variables, and output variables of the control unit that performs power usage control according to the present disclosure, and FIG. 5 is a flowchart showing the power usage control process according to the present disclosure.

Referring to FIG. 4, the control unit 20 may include the determiner that performs user profile and usage position determination, stay mode entry determination, heating/cooling necessity determination, and function on/off determination for each usage mode, and the controller that performs vehicle power usage control in the stay mode depending on determination results by the determiner.

In the state in which the vehicle is stopped in the P gear position and then the stay mode is activated, if a user who wants to use the stay mode inputs his/her own profile information or selects his/her own profile information that has been input and stored in advance through the input device 11 of the interface unit 10, the determiner receives the user profile information input or selected by the user.

In addition, the determiner receives various information (e.g., required) to perform the stay mode, including information (e.g., required) for power usage control performed when the stay mode is activated. Specifically, the determiner may receive the vehicle status information and environmental information detected by the sensors in the vehicle.

More specifically, the determiner may receive the ambient temperature detected by the ambient temperature sensor, the vehicle interior temperature detected by the interior temperature sensor, and the vehicle position information obtained by the GPS receiver.

In the present disclosure, because, in order to execute the stay mode, the vehicle must be stopped in the P gear position input state, a place where the user, such as a driver, may rest or stay in the vehicle in the P-gear position stopped state while using the electric devices in the vehicle is needed, and in this way, a vehicle position (e.g., parking position) where the stay mode is performed is input to the determiner of the control unit 20.

In addition, the determiner may receive passenger boarding position information detected by the passenger detection sensor. The passenger boarding position information may include information on a passenger boarding position and number of passengers in the vehicle interior.

In addition, the determiner may receive current battery SoC information in real time as the battery status information from the BMS 24, and may receive other (e.g., necessary) information, such as a target cooling/heating temperature, which is a user set temperature, and a target cooling/heating air volume, which is a user set air volume, as user set information from the air conditioning control unit 22.

That is, the determiner receives various pieces of information (e.g., required) for power usage control performed during the stay mode, and when the stay mode is activated, the determiner may receive the target cooling/heating temperature and the target cooling/heating air volume that are predetermined for each detailed usage mode or changed by manipulation, or the target cooling/heating temperature and the target cooling/heating air volume that the user sets or inputs through the input device 11 to use the usage mode (see FIG. 3).

This information may be information that the determiner (e.g., directly) receives from the input device 11 of the interface unit 10 and stores, or information that is input, selected, and stored in another control unit, and then input from the other control unit to the determiner when the corresponding usage mode is used.

In addition, the determiner may receive environmental information at the current vehicle position where the stay mode is performed. At this time, the determiner may receive the environmental information at the current vehicle position wirelessly received from an external system (not shown) outside the vehicle through the AVNT system 60, and the environmental information may be weather information.

Specifically, the environmental information may include one or both of sunlight information and external air volume information at the current vehicle position. In addition, instead of the ambient temperature detected by the ambient temperature sensor, an ambient temperature received from the external system outside the vehicle through the AVNT system 60 and then input to the determiner may be used as the environmental information in the present disclosure.

Hereinafter, the power usage control method of the vehicle according to an example embodiment of the present disclosure will be described in detail with reference to FIGS. 1 to 5.

When the vehicle having the stay mode is stopped in the P gear position and then the stay mode is activated, the determiner of the control unit 20 performs a user profile and usage position determination process (Operation S1 of FIG. 5). At this time, the determiner confirms the user currently using the stay mode from the currently input or selected user profile information, and at the same time, confirms the current vehicle position as the input stay mode usage position.

In addition, the determiner confirms learning information about the current user of the stay mode, and the learning information may include usage pattern information of the stay mode, such as the usage position and usage time of the previous stay mode that have been learned and stored in advance for the current user, and the setting information on the operating status of each of the electric devices used. In addition, the learning information may further include information on the previously used usage mode.

Next, the determiner performs a process of determining entry to the stay mode (Operation S2), and in this process, the determiner confirms whether activation of the stay mode is selected after the vehicle is stopped in the P gear position.

In addition, if activation of the stay mode is selected through the input device 11 and the vehicle enters the stay mode, the control unit 20 controls the display 12 to display the detailed usage modes that are available and selectable (Operation S3).

Subsequently, the determiner of the control unit 20 confirms a detailed usage mode selected by the user through the input device 11 (Operations S3, S4, S5, and S6), and confirms the setting information of the selected detailed usage mode.

Then, the determiner performs a cooling/heating necessity determination process, and determines whether cooling or heating of the vehicle interior is required based on the environmental information collected from the vehicle. Here, the environmental information to determine whether cooling or heating is required may include the ambient temperature, the vehicle interior temperature or a user set temperature. Here, the user set temperature becomes a target cooling/heating temperature.

Specifically, the determiner may determine whether cooling or heating is required currently in the vehicle based on the ambient temperature and the interior temperature, which are values detected by the sensors at the current vehicle position (e.g., usage position), or the ambient temperature and the target cooling/heating temperature, and if a difference between the ambient temperature and the interior temperature, or the ambient temperature and the target cooling/heating temperature exceeds a set temperature, the determiner may determine that cooling or heating is required.

Alternatively, the determiner may be provided to determine whether cooling or heating is required selectively using the environmental information, user's air-conditioning setting information, and user's previous cooling/heating learning information along with the current vehicle position information.

Specifically, the determiner may determine whether cooling or heating is currently required in the vehicle selectively using at least some of information, such as the current vehicle position, the sunlight amount, the external air volume, the target cooling/heating temperature, a blower level or target cooling/heating air volume set by the user, the user's previous cooling/heating learning information, the ambient temperature, or the interior temperature.

In addition, the determiner confirms the setting information set for the usage mode selected by the user (e.g., including information set or changed by the user). At this time, the determiner confirms the setting information on the above-described operating status of each electric device for the corresponding usage mode, including the on/off setting information of electric devices installed in or connected to the vehicle, in order to perform the function set in the usage mode selected by the user.

As an example of the setting information on the operating status of each electric device to perform the function set in each usage mode, in the case of the relax mode, the target cooling/heating temperature (e.g., the user set temperature in the relax mode) may be set to 21° C., interior lights may be turned off, the audio device of the AVNT system 60 may be turned off, the video device of the AVNT system 60 may be turned off or the brightness of the video device may be adjusted (user-settable), the air conditioner 30 may be turned on and the internal air mode of the air conditioner 30 may be turned on, the target cooling/heating air volume (i.e., the user set air volume in the relax mode) may be set to blower level 3, and the Ergo motion seat 40 may be turned on.

If the driver starts driving at dawn, drives for a long time, and then takes a rest at a rest area for safe driving, the relax mode, which is a rest mode, may be selected, and at this time, the vehicle interior is made dark, the Ergo motion seat 40 is adjusted to maintain the comfortable seating posture of the driver, and the air conditioner 30 is turned on because the vehicle may become hot even if the sunlight is blocked.

In addition, in the case of the fun mode, the target cooling/heating temperature (e.g., the user set temperature in the fun mode) may be set to 18° C., the interior lights may be turned on, the audio or video device of the AVNT system 60 may be turned on, the air conditioner 30 may be turned on and the internal air mode of the air conditioner 30 may be turned on, the target cooling/heating air volume (e.g., the user set air volume in the fun mode) may be set to blower level 5, the Ergo motion seat 40 may be turned on, and a wired/wireless charging port may be activated.

To avoid rush hour, after the driver has arrived at a company parking lot about 30 minutes before work starts, the driver may spend time playing portable games or watching video content to enjoy his/her own time in the vehicle before going to work. At this time, the fun mode, which is an entertainment mode, may be selected, and when watching video content, sound, lighting, and appropriate vibration through the seat 40 may be provided to create an emotional atmosphere, and thereby, the driver may start his/her day happily.

In addition, if a sleep mode is selected, all the lighting devices 70 in the vehicle, including the interior lights, may be turned off, the screen of the display 12 of the AVNT system 60 may be turned off.

The relax mode and the sleep mode may be set as the same usage mode without a separate sleep mode, but the sleep mode for sleep only may be additionally set separately from the relax mode, or the sleep mode may be set and provided as a custom mode in which the user sets setting information, such as on/off of each electric device, as desired.

In addition, as another usage mode of the stay mode, a custom mode in which wired and wireless functions are turned off when a mobile phone is fully charged, or operation of the air conditioner 30 is controlled to the temperature and air volume set by the user, or a custom mode in which on/off control and brightness control of the interior lights set by the user, video brightness control, audio volume control, on/off control of the Ergo motion seat 40, and the like are performed may be set and provided to be used.

It may be cumbersome to adjust or turn on/off the functions of the electric devices in the vehicle one by one every time the stay mode is used, and therefore, a custom mode in which the operating status of each electric device is set is created in advance as the user's own stay mode, and (e.g., only) if the user selects the corresponding custom mode with a single touch, the environment desired by the user may be implemented and provided in the vehicle.

Next, the controller may perform a process of calculating power using the learning information for each detailed usage mode including the usage pattern information, such as the setting information on the user, the usage position and usage time, and the operating status of each electric device used, a process of limiting and distributing the power of the detailed usage mode selected by the user, and a process of calculating the expected available time of the detailed usage mode selected by the user. The expected available time of the detailed usage mode may mean the maximum time for which the detailed usage mode is available.

The controller may exchange information or perform cooperative control with the determiner to execute the stay mode or perform power usage control of the selected detailed usage mode, use the determination results by the determiner to perform power usage control, and perform control at the request of the determiner.

In the present disclosure, the controller of the control unit 20 learns the usage pattern of the stay mode for each user, and then calculates operating power for each detailed usage mode using the learning information for each detailed usage mode including the learned user pattern information, such as the setting information on the user, the usage position and usage time, and the operating status of each electric device used.

For example, driver 1 often uses the relax mode for 20 minutes before work starts, and if driver 1 uses the relax mode for a set time before work starts, setting information on the user, the usage position, the usage time, and the operating status of each electric device may be stored as driver 1's learning information for the relax mode. At this time, if driver 1 changes setting values (e.g., adjusts setting values, such as a temperature, an air volume, intensity, brightness, and the like) through manipulation, the changed setting values may be stored as the learning information.

In the same manner, driver 2 often uses the fun mode for 40 minutes at lunch time, and if driver 2 uses the fun mode for a set time at lunch time, setting information on the user, the usage position, the usage time, and the operating status of each electric device may be stored as driver 2's learning information for the fun mode.

In the present disclosure, after the user selects one of the detailed usage modes in Operations S3, S4, S5, S6 of FIG. 5, the controller calculates the operating power of all the electric devices set to be operated in the selected detailed usage mode based on the setting information for each electric device in the corresponding detailed usage mode.

As described above, when the operating power of all the electric devices operated in the detailed usage mode is determined, the controller calculates an integrated power limit of the detailed usage mode considering a margin set for the calculated operating power of all the electric devices.

At this time, the controller may calculate the integrated power limit, which is the maximum available power in the detailed usage mode, by subtracting the margin from the calculated operating power of all the electric devices.

In addition, the controller calculates the operating power of each electric device (e.g., each of the air conditioner, the converter, the heating device, and the like) set to be operated when the detailed usage mode is executed based on the setting information of the detailed usage mode selected by the user.

In addition, the controller determines the power limit of each electric device, such as an air conditioner power limit, a converter (LDC) power limit, and a heating device power limit, based on the calculated operating power of each electric device and the integrated power limit.

Here, the controller determines the power limit of each electric device, which is the maximum available power of each electric device considering a margin for the operating power of each electric device, such as the air conditioner power limit, the converter (LDC) power limit, and the heating device power limit, by distributing the integrated power limit based on the calculated operating power of each electric device (Operation S7 of FIG. 5).

When the detailed usage mode is executed, the air conditioner power limit, the converter (LDC) power limit, and the heating device power limit, which do not exceed air conditioner operating power, converter power (converter output power), and heating device operating power, respectively, are determined by distributing the integrated power limit to each electric device considering the air conditioner operating power, the converter power, and the heating device operating power used depending on the setting information and the respective margins thereof.

For example, when distributing the integrated power limit, the ratio of the air conditioner operating power, the converter power, and the heating device operating power may be used as a distribution ratio, and the integrated power limit may be distributed into the air conditioner power limit, the converter power limit, and the heating device power limit depending on the distribution ratio.

Table 1 below shows an example of distribution of the integrated power limit. Referring to Table 1, it may be seen that the sum of the air conditioner power limit, the converter power limit, and the heating device power coincides with the integrated power limit in each of the relax mode, the entertainment mode, and the custom mode.

TABLE 1

| | | Rest | Entertainment | Custom |
|---|---|---|---|---|
| Power limit | Normal mode | mode | mode | mode |
| Air conditioner | Real-time | 500 W | 500 W | 900 W |
| power (limit) | usage | | | |
| Converter | Real-time | 100 W | 100 W | 50 W |
| power (limit) | usage | | | |
| Heating device | Real-time | 50 W | 800 W | 700 W |
| power (limit) | usage | | | |
| Total load power | Total | 650 W | 1400 W | 1650 W |
| (Integrated | real-time | | | |
| power limit) | usage | | | |

In Table 1, the normal mode indicates a mode other than the stay mode in the present disclosure, that is, a mode in which the vehicle does not enter the stay mode. In the conventional stay mode, power limitation is not performed and the operating power of each electric device becomes the real-time usage amount, and thus, there is no difference with the normal mode.

As described above, once the power limit of each electric device is determined by distributing the integrated power limit, the controller performs control for the detailed usage mode selected by the user, and controls the operating status of each device depending on the setting information of the selected detailed usage mode (S8, S9, S10).

In this process, the use of the air conditioner operating power, the converter power, and the heating device operating power may be limited to be within the respective determined power limits, and the operating status of each electric device may be adjusted to limit the use of power.

Here, the converter power may include power used by the seat 40, the AVNT system 60, the lighting device 70, and the like, and the heating device power may include power used by the seat heating wire, and the like

In the present disclosure, the power usage of the air conditioner may be controlled by the controller and the air conditioning control unit 22, and the power usage of the heating device may be controlled by cooperation between the controller and the device-specific control unit 27 (e.g., for controlling the heating device).

In addition, in the present disclosure, the power usage through the converter 50 may be controlled by cooperation between the controller and the converter control unit 25, and furthermore, cooperation in which the seat control unit 23, the AVNT control unit 26, and the device-specific control unit 27 (e.g., for controlling the lighting device) selectively participate.

Thereafter, if the user changes the setting information on the operating status of each electric device through additional manipulation, and even at least one of the air conditioner operating power, the converter power, or the heating device operating power used depending on the changed setting information exceeds the limit thereof, the controller may terminate and release the stay mode and switch to the normal mode (Operations S11 and S12).

After switching to the normal mode, the controller may calculate the current real-time electric field load and power usage amount (Operation S13), calculate an expected available time based on the calculated real-time power usage amount (Operation S14), and then display the calculated expected available time through the display 12.

If the air conditioner operating power, the converter power, and the heating device operating power are being used within the respective limits thereof without additional user manipulation, the controller may maintain the corresponding detailed usage mode of the stay mode, calculate the expected available mode, which is the maximum time for which the corresponding detailed usage mode is available (Operations S11 and S14), and then display the calculated expected available time through the display 12.

Here, the expected available time of the detailed usage mode, which is being executed, may be calculated based on the power usage status of each electric device and the battery status (e.g., battery SoC, and the like), and the calculated expected available time may be displayed through the display 12. In addition, the current power information in use may be displayed through the display 12.

As is apparent from the above description, a method of controlling electric power usage of a vehicle according to the present disclosure may secure a longer power usage time through efficient power usage control while the stay mode is being executed at a user's request.

In addition, the method of controlling the electric power usage of the vehicle according to the present disclosure may provide a user (e.g., driver) with various information related to power usage when using the stay mode, and allows stay mode settings to be customized for the user so that the stay mode may be used in a personalized manner.

In addition, the method of controlling the electric power usage of the vehicle according to the present disclosure may enable the stay mode to be more efficiently used based on information learned depending on the user or usage position of the stay mode.

Although the embodiments of the present disclosure have been described in detail above, the scope of the present disclosure is not limited thereto, and various modifications and improvements may be made using the basic concept of the present disclosure provided in the claims and in the scope of the present disclosure.

What is claimed is:

1. A method of controlling electric power usage of a vehicle having a stay mode comprising:
displaying, by a control unit, information on available usage modes of the stay mode on a display;
when a usage mode of the available usage modes is selected through an input device, determining, by the control unit, a total operating power of electric devices set to be operated in the selected usage mode based on setting information of an operating status of each electric device set for the usage mode, and determining an integrated power limit from the total operating power of the electric devices;
determining, by the control unit, a power limit of each electric device distributed from the determined integrated power limit based on the setting information of the operating status of each electric device; and
operating, by the control unit, each electric device using battery power depending on the setting information of the operating status of each electric device, and limiting power usage of each electric device depending on the determined power limit of each electric device.

2. The method of claim 1, wherein the controller is configured to include a plurality of usage modes.

3. The method of claim 2, wherein a user selects one of the plurality of usage modes.

4. The method of claim 1, wherein the usage modes comprise a custom mode created by a user.

5. The method of claim 4, wherein the custom mode is a usage mode created by the user by selecting the electric devices desired to be operated.

6. The method of claim 5, wherein the custom mode further is created by the user selecting setting information on operating statuses of the selected electric devices.

7. The method of claim 6, wherein the custom mode further is created by storing the setting information in the controller.

8. The method of claim 3, further comprising determining, by the controller, user profile information input or selected by the user.

9. The method of claim 8, wherein the controller determines the user from the input or selected user profile information.

10. The method of claim 9, wherein the controller then displays information on usage modes available to the user determined by the controller.

11. The method of claim 1, further comprising:
displaying, by the control unit, information configured to enable selection or input of activation of the stay mode through the display, when the vehicle is stopped and is in a park (P) gear position.

12. The method of claim 11, further comprising:
activating, by the control unit, the stay mode, when a user selects or inputs the activation of the stay mode through the input device.

13. The method of claim 1, wherein the electric devices are devices operated using the battery power.

14. The method of claim 13, wherein the electric devices
comprise at least one of an air conditioner, a seat, an audio device, a video device, a lighting device, or a heating device.

15. The method of claim 1, wherein the power limit of each electric device comprises at least one of:
an air conditioner power limit configured to limit operating power of an air conditioner;
a converter power limit configured to limit operating power of electric devices configured to receive the battery power through a converter; or
a heating device power limit configured to limit operating power of a heating device.

16. The method of claim 1, wherein, in determining the integrated power limit, the controller determines the integrated power limit as a value obtained by subtracting a predetermined margin from the total operating power of the electric devices.

17. The method of claim 1, wherein, in determining the power limit of each electric device, the controller:
determines an operating power of each electric device set to be operated in the selected usage mode based on the setting information of the operating status of each electric device.

18. The method of claim 17, wherein, in determining the power limit of each electric device, the controller:
determines the power limit of each electric device, which is the maximum available power of each electric device, by distributing the integrated power limit based on the determined operating power of each electric device.

19. The method of claim 1, wherein, when the setting information of the operating status of each electric device is changed by additional user manipulation during execution of the selected usage mode, and the operating power of each electric device exceeds the power limit of each electric device while each electric device is operated depending on the change to the setting information, the controller terminates and releases the stay mode.

20. The method of claim 1, wherein the controller:
determines an expected available time, which is a maximum time for which the selected usage mode is available, based on a power usage status of each electric device and battery status information; and
displays the determined expected available time through the display.
